(19) United States
(12) Patent Application Publication
(10) Pub. No.: US 2005/0137315 A1
(43) Pub. Date: Jun. 23, 2005

(54) L3-silica/polyurethane thermally insulating nanocomposite

(76) Inventors: Ilhan A. Aksay, Princeton, NJ (US); Christopher M. Wahl, Hoboken, NJ (US); Daniel M. Dabbs, Princeton, NJ (US); Iskender Yilgor, Istanbul (TR)

Correspondence Address: MCCARTER & ENGLISH, LLP, FOUR GATEWAY CENTER, 100 MULBERRY STREET, NEWARK, NJ, 07102, US

(21) Appl. No.: 10/842,251

(22) Filed: May 10, 2004

Related U.S. Application Data
(60) Provisional application No. 60/493,680, filed on Aug. 8, 2003.

(51) Int. Cl. C08K 3/34

(52) U.S. Cl. 524/492

(57) ABSTRACT

The present invention provides thermal insulator composites based upon nanostructured L₃-silica microparticles and polyurethane foam chemistry that are both easy to process and have superior insulating properties for use in household and commercial refrigeration, construction, and shipping applications. The composite material retains many of the attractive processing characteristics of polyurethane foams such as volume expansion and shape-filling during polymerization and demonstrates a total thermal conductivity between 32 and 44% that of commercially available polyurethane foams.

### RELATED APPLICATIONS

This application claims the benefit of U.S. Provisional Application Ser. No. 60/493,680 filed Aug. 8, 2003, the entire disclosure of which is expressly incorporated herein by reference.

### BACKGROUND OF THE INVENTION

1. Field of the Invention

The present invention relates to a thermally insulating composite produced from nanostructured L₃-silica microparticles and polyurethane foam.

2. Related Art

For many thermal insulation applications, composites composed of a solid component and a gaseous component are utilized. The solid component confers structural stability to the material, whereas the gas confers low thermal conductivity by virtue of the relative infrequency of energy-transferring collisions (D. Halliday, R. Resnick, J. Walker, Fundamentals of Physics Extended, 5th Edition New York: John Wiley & Sons, 1997, 454-502). In the design of such materials, heat transport through the bulk is determined by heat transport through the solid fraction and heat transport through the gaseous fraction of the bulk composite.

Heat transport through the solid component is dependent on several factors, such as the inherent conductivity of the solid, the tortuosity of the path through the solid, and the volume fraction of the solid. Heat transport through the gaseous component depends on the conductivity of the gas, convection processes, gas volume fraction, and, if the material feature sizes are small enough, the mean free path of individual gas molecules.

Rigid polyurethane foam insulation is used in applications ranging from refrigeration to housing. The use of this material as an insulator is due to the many attractive properties that it exhibits. The overall thermal conductivity of polyurethane foam is approximately 0.020 to 0.030 W/m·K, with the conductivity of the solid portion being greater than 0.1 W/m·K. However, the structure of the material leads to a high degree of tortuosity. Additionally, the solid fraction of the material is usually less than 10%. (G. Oertel, Polyurethane Handbook, New York: Macmillan Publishing Co., Inc., 1985, 7-116, 234-314).

The thermal properties of polyurethane foams are dependent upon the inherent thermal conductivity of the cell gas. In order to achieve the lowest overall thermal conductivity, the cell gas must be a highly insulating chlorofluorocarbon such as monofluorotrichloromethane or difluorodichloromethane. Due to environmental effects, the use of these materials has become restricted and the search for an effective replacement is an area of active research (Environmental Protection Agency, “Protection of Stratospheric Ozone.” Clean Air Act (1993) Section 610 Class I Vol 58.10). For foam systems produced from environmentally hazardous chlorofluorocarbons (CFCs), the conductivity of the cell gas is less than 0.008 W/m·K. Because the typical cell size in these foam structures is not larger than 500 μm, convection processes are insignificant. The cell gas often accounts for 80 to 90% of the volume of a polyurethane foam material. It is this structure that accounts for the low overall thermal conductivity of the foam.

Polyurethane foams are also relatively easy to process. For example, the liquid precursors can be injected directly into a refrigerator housing, and the polymerization allowed to occur in situ. Additionally, there exists a volume expansion associated with the foaming of polyurethane, so the precursors can be injected into molds with complex geometries and the expanding foam will exactly fit the mold shape. This volume expansion also aids in the adhesion of the foam to surfaces. Laminates of polyurethane with metallic face sheeting exhibit both desirable insulating properties as well as robust mechanical properties.

Silica aerogel and xerogel materials show promise in thermal insulation applications. The typical thermal conductivity of an aerogel is 0.017 W/m·K, and can be as low as 0.008 W/m·K (D. Quenard, B. Chevalier, H. Salee, F. Olive, D. Giraud, Revue De Metallurgie-Cahiers D Informations Techniques, 96 (1999) 599-600). The extremely small feature sizes of these materials, on the order of nanometers, lead to interesting thermal conductivity properties. At room temperature and pressure, the mean free path of oxygen is approximately 100 nm (D. Halliday, R. Resnick, J. Walker, Fundamentals of Physics Extended. (5th Edition, New York: John Wiley & Sons, 1997, 491). Thus, if the channel size of the material is smaller than the mean free path of the gases within the material, which is often air, the molecules will tend to collide with the walls of the silica more often than with other gas molecules. Under such conditions, the motion of the gas molecules is severely retarded by the presence of the silica matrix, which causes the gas to have an effective thermal conductivity that is approximately 50% that of the same gas in free space (S. Q. Zeng, A. Hunt, R. Greif, Journal of Non-Crystalline Solids, 186, 1995, 264-270). Additionally, the transport of heat through the solid fraction of the material is limited by both the low solids content of aerogel materials, less than 15% by volume (L. W. Hrubesh, J. F. Poco, Journal of Non-Crystalline Solids, 188, 1995, 46-53), as well as the tortuosity of the nanostructure (J. Fricke. Sol-Gel Technology for Thin Films, Fibers, Preforms, Electronics, and Specialty Shapes, Park Ridge: Noyes Publications, 1988, 233-234). Indeed, aerogels typically have lower thermal conductivity than xerogels because of the lower solids content.

However, the use of such silica materials has been limited by several processing factors. Because many of the gel properties depend on feature sizes on the order of nanometers, supercritical drying processes are often needed in order to produce bulk specimens of these materials that have a high degree of porosity (J. Fricke, 1988). Supercritical drying is a processing step in which a wet gel specimen is subjected to temperatures and pressures that cause the surrounding fluid to enter a supercritical phase, a state in which the differentiation between liquid and gas breaks down (J. D. Henry, M. E. Prudlich, W. Eykamp, T. A. Hatton, K. P. Johnston, R. M. Lemert, R. Lemlich, C. G. Moyers, J. Newman, H. A. Pohl, K. Pollock, M. P. Thien, Perry's Chemical Engineers' Handbook, New York: McGraw-Hill, 1997, 22.14-22.18). This transition is defined by two material properties, the critical temperature, Tc, and the critical pressure, Pc. For methanol, for example, these parameters have values of 239.4° C. and 79.78 atm, respectively (J. A. Dean, Lange's Handbook of Chemistry, New York: McGraw-Hill, Inc, 15th ed., 1999). Because there are no liquid/gas interfaces in a supercritical fluid, the capillary pressure usually associated with drying processes disappears. By avoiding capillary pressures, the fluid can be removed without the collapse of the nanostructure of the material. However, this processing step has several disadvantages. Even for small specimens, it is an expensive procedure, both for energy costs as well as capital equipment, and it becomes progressively more difficult for larger samples (G. Carlson, D. Lewis, K. McKinley, J. Richardson, T. Tillotson, Journal of Non-Crystalline Solids, 186, 1995, 372-379). Additionally, the technique is totally inappropriate for filling applications, such as those that occur in refrigerator manufacture and building construction, because the material could not be exposed to the supercritical fluid. Moreover, there is often a volume decrease associated with the solidification of a gel material, so in situ solidification is much less feasible. This effect would be especially problematic if the material were to be used in items of complex geometry. The use of preformed silica powders is also unattractive because of the difficulty associated with packing these powders in molds.

L₃-silica is an aerogel-like material that is formed via the silicification of a self-assembled surfactant bilayer template. The L₃ template is a lyotropic, self-assembled, nanostructured liquid crystal (K. M. McGrath, D. M. Dabbs, N. Yao, I. A. Aksay, S. M. Gruner, Science, 277, 1997, 552-555). The structure of the liquid crystal, which is defined by the arrangement of an amphiphilic bilayer within an aqueous medium, is a randomly oriented, isotropic, bicontinuous channel network that divides the aqueous phase into two equivalent subvolumes. Unlike other surfactant systems, the channel structure of L₃ is not defined directly by surfactant micelles, but rather by the orientation of the bilayer within the aqueous phase; the channels themselves are filled with the aqueous medium. Thus, the channel size of the L₃ phase can be varied continuously simply by controlling the amount of aqueous phase that is present (K. M. McGrath, D. M. Dabbs, N. Yao, K. J. Edler, I. A. Aksay, S. M. Gruner, Langmuir, 16, 2000, 398-406). Such “tuning” is impossible for systems in which the channel structure is defined explicitly by the size of the surfactant molecule. Additionally, by virtue of the manner in which the channel size is defined, there exists an extremely narrow channel size distribution; all the channels are essentially the same size.

Lyotropic liquid crystalline L₃-phase silicated nanoporous monolithic materials and methods for their production are described in U.S. Pat. No. 6,638,885 and U.S. patent application Ser. No. 10/659,173, filed Sep. 10, 2003, a continuation thereof, the contents of which are hereby incorporated by reference.

Therefore, what is needed and has not been heretofore available, is a thermal insulation composite that has the high-performance thermal properties of nanostructured silica materials, yet is characterized by the ease of processing associated with modern polyurethane foams.

### SUMMARY OF THE INVENTION

The present invention provides a thermal insulating composite comprising an L₃-silica liquid crystal and rigid polyurethane. The composite of the invention comprises 2-30% by weight L₃-silica and 70-98% by weight polyurethane foam. The composite has a thermal conductivity of from about 0.008 to 0.015 W/m·K. The composite of the invention has a gaseous cell size of from about 200 to 500 μm in diameter.

In one embodiment, the composite of the invention comprises an L₃-silica which is produced by templating with a ceramic precursor a lyotropic liquid crystalline L₃ phase. The L₃ phase consists of a three-dimensional, random, nonperiodic network packing of a multiple connected continuous membrane. The ceramic precursor can be a metalloorganic or metal salt precursor to oxide or non-oxide ceramics. For example, the ceramic precursor can be tetramethoxysilane (TMOS) or tetraethoxysilane (TEOS).

The present invention also provides a method of producing a thermal insulating composite comprising the steps of providing two polyurethane precursor components, a polymeric isocyanate and a polyol mixture; providing an L₃-silica liquid crystal; mixing the L₃-silica liquid crystal with the polyol mixture precursor; and mixing the liquid crystal and polyol mixture with the polymeric isocyanate precursor to form a L₃-silica liquid crystal/rigid polyurethane thermal insulating composite. The composite structures are formed mixing polyurethane precursors at 70-98% by weight and L₃-silica at 2-30% by weight.

In one embodiment, the method of producing the composite comprises mixing a L₃-silica which is produced by templating with a ceramic precursor a lyotropic liquid crystalline L₃ phase, wherein the L₃ phase consists of a three-dimensional, random, nonperiodic network packing of a multiple connected continuous membrane. The ceramic precursor can be a metalloorganic or metal salt precursor to oxide or non-oxide ceramics. For example, the ceramic precursor can be tetramethoxysilane (TMOS) or tetraethoxysilane (TEOS). The L₃-silica can have a particle size of from 1 to 500 μm.

### BRIEF DESCRIPTION OF THE DRAWINGS

Other important objects and features of the invention will be apparent from the following Detailed Description of the Invention taken in connection with the accompanying drawings in which:

FIG. 1 is an idealized schematic of the L₃-silica/polyurethane composite material produced according to the invention.

FIG. 2 shows scanning electron microscope images of rigid polyurethane foam formed according to the invention. FIG. 2A shows the foam at 25× magnification; FIG. 2B shows the foam at 95× magnification.

FIG. 3 shows scanning electron microscope images of L₃-silica powder produced according to the invention. FIG. 3A shows the powder at 27× magnification; FIG. 3B shows the powder at 212× magnification; FIG. 3C shows the powder at 227× magnification; FIG. 3D shows the powder at 3624× magnification.

FIGS. 4A and 4B show scanning electron microscope images of the L₃-silica/polyurethane composite produced according to the invention. FIG. 4A shows the silica particles at 45× magnification; FIG. 4B shows the silica particles at 186× magnification.

FIG. 5 shows the calculated thermal conductivity of a polyurethane foam sample B and the L₃-silica/polyurethane composite produced as described herein.

FIG. 6 shows the relative heights of unmodified (control) and L₃ modified polyurethane foams. Sample 2, control; Sample 3, 5% by weight L₃; Sample 4, 10% by weight L₃; and Sample 5, 15% by weight L₃.

FIG. 7 shows an optical microscope image of polyurethane foam containing no L₃.

FIG. 8 shows an optical microscope image of polyurethane foam composite containing 5% by weight of L₃.

FIG. 9 shows an optical microscope image of polyurethane foam composite containing 10% by weight of L₃.

FIG. 10 shows an optical microscope image of polyurethane foam composite containing 15% by weight of L₃.

### DETAILED DESCRIPTION OF THE INVENTION

A. Synthesis of Rigid Polyurethane Foam

The chemistry of polyurethane is known (See, e.g., G. Oertel, Polyurethane Handbook. New York: Macmillan Publishing Co., Inc., 1985, 7-116, 234-314). For the synthesis of rigid polyurethane foams used in thermal insulation applications, several constituents including reactive precursors are combined. Each of the reactants must be at least bifunctional in order to form macromolecules. For polyurethane foams it is preferable to have an average of greater than two functionalities in each component. Polyurethane chemistry is based upon a polyaddition in which a nucleophile, such as hydroxyl- or amino-containing compounds, is allowed to attack an isocyanate group. The strong reactivity that isocyanates exhibit in the presence of nucleophiles can be explained by the relatively large positive character of the carbon atom within the isocyanate group. The isocyanate chemical structure is

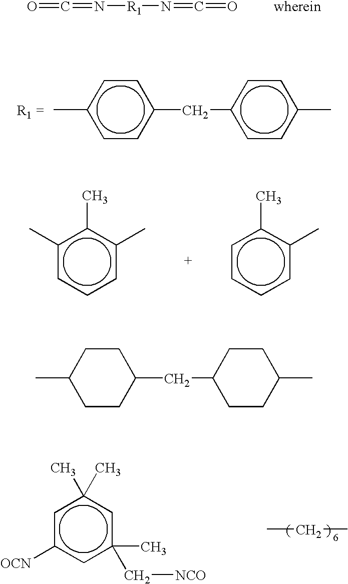

In one embodiment, the isocyanate is a polyisocyanate. The polyisocyanate can be polymeric methylene diphenylene diisocyanate (polymeric MDI) based, such as PAPI 27 (Dow), Mondur M (Bayer), Rubinate M, or Lupranate M205. The polyisocyanate is added at about 80-100 pbw.

Urethane formation involves the nucelophilic addition of an alcohol to an isocyanate to form a urethane linkage. Suitable alcohols can include: 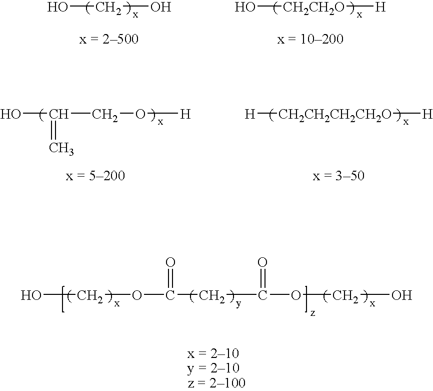
The alcohol can be a polyol having the structure: 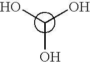
wherein the arms are alkylene oxide and the center is glycerol trimethylolpropane sucrose.

A preferred polyol is a sucrose-based polyether polyol, such as is commercially available under the tradename MULTRANOL® (Bayer Polymers). The R1 and R2 groups shown in the above reaction can be varied as is known in the art to manipulate the properties of the final article such as molecular weight, hydrophobic/hydrophilic balance, and primary or secondary OH reactivity. The polyol is added at about 100 pbw.

The stoichiometric amounts of the diisocyanate and diol(s) lead to the formation of polyurethanes: 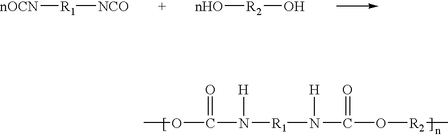
wherein R₁ can be an aryl, alkyl or aralkyl radical, and R₂ can be an alkyl, aralkyl, polyalkylene oxide or polyester radical.

Several other constituents in addition to the reactive isocyanate and alcohol precursors must be added, including a blowing agent, a surfactant and a catalyst in the synthesis of a polyurethane foam.

The blowing agent is a low-boiling liquid that absorbs part of the reaction exotherm during vaporization. This vaporization process leads to the formation of many small bubbles within the gelling polyurethane. It is these bubbles that give rigid foams such low thermal conductivities. Although chlorofluorocarbons have traditionally been used as blowing agents, their use has been phased out due to their adverse environmental effects. Suitable blowing agents can include methylene chloride, cyclopentane, acetone, hexane and water. The blowing agent is added at 20-60 pbw.

A surfactant is used in the synthesis of polyurethane foam to stabilize the forming cells by lowering the surface tension at the gas/solid interface. Suitable surfactants can include polydimethylsiloxane-alkyl or -alkylene ether bases oligomers with different backbone structures and compositions. It has been found that siloxane-based polymers are particularly useful surfactants in the synthesis of polyurethane foams, as typical organic surfactants appear to have little effect on the surface tension of an organic polymer. A preferred surfactant is poly[dimethylsiloxane-co-methyl(3-hydroxypropyl)siloxane]-graft-poly(ethylene glycol)methyl ether in 85% ethylene oxide. The surfactant is added at 1.0-2.0 pbw.

Catalysts are also added to polyurethane foams. Catalysts cause the reaction to take place in a reasonable time frame, and ensure that the reaction proceeds quickly enough that the reaction exotherm can vaporize the blowing agent. Suitable catalysts include tertiary amines, salts and organometallic compounds. Organometallic compounds, such as stannous octoate and dibutyltindilaurate, are electrophilic and catalyze the reaction by stabilizing a high-energy isocyanate transition state. Organic metal catalysts are typically used in water-free syntheses. A triamine catalyst can be added at 0.5-4.0 pbw; a tin catalyst (T-9 or T-12) can be added at 0-0.5 pbw.

Water may be added to the reaction mixture at 0-2.5 pbw.

To prepare a polyurethane foam, two precursor components are combined and mixed until homogenous using methods known in the art. The first component is the polymeric isocyanate, at 80-100 pbw. The second component, prepared in a separate container is a polyol mixture, which includes polyol at 100 pbw, surfactant at 1.0-2.0 pbw, a triamine catalyst at 0.5-4.0 pbw, a tin catalyst at 0-0.5 pbw, water at 0-2.5 pbw, and the blowing agent at 20-60 pbw, which are combined and mixed until homogenous. The polymeric isocyanate and polyol are then combined. Foaming occurs with up to about a 2000% increase in volume in the material. However, according to the present invention, these methods are modified by the incorporation of L₃ silica at 2-30% by weight as described herein.

B. Synthesis of L₃-Silica

L₃ silicas are described in K. M. McGrath, D. M. Dabbs, N. Yao, I. A. Aksay, S. M. Gruner, Science 277 (1997) 552-555) and U.S. Pat. No. 6,638,885. L₃ liquid crystals can be produced, for example, by the quasi-ternary system of cetylpyridinium chloride (CpCl), hexanol, and aqueous 0.2 M HCl as described (K. M. McGrath, D. M. Dabbs, N. Yao, K. J. Edler, I. A. Aksay, S. M. Gruner, Langmuir 16 (2000) 398-406). CpCl acts as the primary surfactant and the hexanol stabilizes the surfactant tail, thereby altering the bilayer curvature. The only requirement of the aqueous phase is that it have a particular chloride ion concentration; the source of this ion is immaterial. The CpCl-hexanol-HCl system is capable of self-assembling into a variety of nanostructures. The thermodynamically stable conformation is dependent primarily on the ratio of CpCl to hexanol, but is also affected by the relative amount of HCl. For the production of the L₃ phase, the mass ratio of hexanol to CpCl should be approximately 1. The phase stability is relatively insensitive to the amount of HCl. This is important, as the relative amount of HCl is the factor used to control channel size within the L₃ phase domain. The channel size of the L₃ crystal is controlled by adjusting the relative amount of the chloride-containing aqueous phase. With this technique, the characteristic distance of the liquid crystal can be varied from about 5 nm to more than 35 nm. This characteristic spacing is found to depend linearly on the fraction of aqueous phase.

The L₃ phase forms in solutions of CpCl.H2O, hexanol, and 0.2N HCl (aq) for hexanol/CpCl.H2O ratios between 1.12 and 1.20 (g/g) and solvent volume fractions between 0.55 to 0.98. Increasing solvent fraction expands the channel diameter in the L3 crystalline phase. Adding a silicon alkoxide such as TMOS perturbs the channel arrangement, but also stabilizes and freezes the channel structure through silicate deposition on the channel walls. The average channel size is indirectly measured using small-angle x-ray diffraction scattering (SAXS) from which the channel diameter can be determined. Channel size ranges from about 30 nm at lower (about 0.55) solvent volume fraction to about 400 nm at high (about 0.96) solvent volume fractions.

The L₃ liquid crystal acts as a template for the formation of a nanostructured ceramic that mimics the structure of the original template. An alkoxysilane silica source is added to the L₃ liquid crystal, eventually forming a ceramic structure that retains the structure of the liquid crystal. Suitable silica sources can include tetraethoxysilane (TEOS), tetramethoxysilane (TMOS), silicic acid (Si(OH)₄), and silicon oxyhydroxide solutes (—O—Si(OH)₂—O—Si(OH₂)—). TMOS is the favored silicon source because it quickly hydrolyzes and is miscible with water. TEOS can be used but must be partially hydrolyzed prior to use to achieve miscibility. The silicon oxyhydroxide solutes have limited solubility at low pH and so must be added slowly to prevent undesirable condensation in solution. Stoichiometrically, one mole of TMOS should be added for every four moles of water, which is present because of the HCl solution. However, it is known that gelation will occur for TMOS amounts ranging from 30% to 275% of the stoichiometric ideal (M. Sze, Characterization of the Pore Structure of L₃ Nanoporous Silica. B. S. E. Thesis, Princeton University, Princeton, N.J., 2002). The L₃-silica was produced as a powder.

C. L₃-Silica/Polyurethane Composite

The L₃-silica/polyurethane composite of the invention is composed of two components: L₃-silica powder and polyurethane foam, each of which is a gas/solid composite. The L₃-silica powder can be mechanically mixed with liquid polyurethane precursors. The polyurethane precursor is prepared such that the total volume will almost exactly fill the interstitial spaces of the L₃ silica powder. In this way, the volume fraction of L₃-silica in the final material will be maximized. Typically, 5-25% by weight of L₃ silica and 75-95% by weight of polyurethane are used to form the composite.

The polyurethane precursors can be foamed according to standard urethane technology modified with the L₃ silica to yield polyurethane foam in which the solid fraction is a polyurethane matrix permeated with small L₃-silica inclusions. These inclusions can lower the bulk thermal conductivity of the solid fraction of the polyurethane. Additionally, the presence of the silica powder facilitates the production of fine foam structures.

To produce the composite of the invention, the L₃ silica powder at 5-25% by weight can be added to the polyurethane precursor polyol mixture containing polyol, surfactant, catalyst and blowing agent and mixed so that the precursor infiltrates the interstitials of the powder. Then the polyurethane precursor polymeric MDI is added to the silica-polyol. This mixture is vigorously mixed and then allowed to stand. The material increases in volume after a few seconds. The total amount of polyurethane which comprises the two components of the polyisocyanate and the polyol mixture, is 75-95% by weight

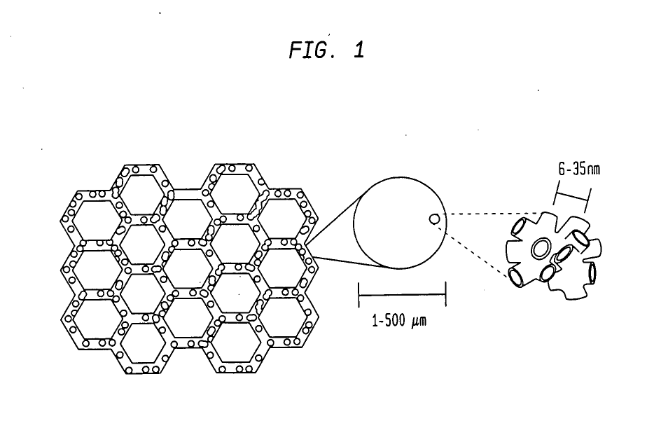

A schematic of a L₃-silica/polyurethane composite structure is shown in FIG. 1. The black walls of the honeycomb structure represent the solid walls of the rigid polyurethane foam, the honeycomb cells represent the gaseous component, and the small pentagons in the solid walls represent L₃-silica inclusions. The nanostructure of the silica particles is also indicated.

The composite of the invention may be used for insulation in household and commercial refrigeration, construction, and shipping applications.

### EXAMPLES

Analytical methods—Scanning electron microscopy (SEM) was performed using a Philips XL-30, which could be loaded with four samples simultaneously—SEM was used to characterize the pore sizes within the polyurethane foams, the particle sizes of L₃-silica powders, and structure and distribution within the composite material.

Sample preparation for SEM analysis—Bulk samples or samples mounted on glass slides were cut to fit on an SEM mount. Powder samples were not cut. The samples were placed in an 80° C. vacuum oven and allowed to bake for at least 24 h, to remove any volatile components that were present. After removal from the oven, the samples were attached to metal SEM mounts with double-sided conducting carbon tape. For powders, the tape was attached to the mount and the mount pressed into the powder in order to collect the substance. Next, for bulk samples and samples mounted on glass slides, conducting carbon paint was used to create a small conducting “tab” that ran from the carbon tape to the surface of the sample. This step was unnecessary for powders. After allowing the carbon paint to dry for at least 24 h, all samples were coated with a 5 nm layer of iridium, using an ion beam sputter coater that bombarded the target metal with an ionized inert gas, to prevent charging effects during the SEM session. After coating, the samples were ready to be viewed. 5 kV of accelerating voltage was usually sufficient to resolve the features of both the foams and the silica particles, but values as high as 20 kV were used to elicit structures on the order of 50 nm. Even with these high voltages, only very slight charging effects were observed.

### Example 1

### Synthesis of Rigid Polyurethane Foam

The polyisocyanate that was used was a polymeric methylene diphenylene diisocyanate (polymeric MDI) (Mondur 489™ Bayer Polymers, LLC Pittsburgh, Pa.) with an average functionality of 3.0, NCO content of 31.5 wt %, and an equivalent weight of 133 g/mol. This material had a viscosity of 700 mPa.s. The polyol monomer that was used Multranol 4030™ (Bayer Polymers, LLC Pittsburgh, Pa.) was a sucrose derivative with an average functionality of 5.2 and a molecular weight of about 624 g/mol. This material had a viscosity of 12.5 Pa.s and was therefore somewhat difficult to work with. Methylene chloride (Product Number 9329-01 J. T. Baker, Mallinckrodt, Inc. Phillipsburg, N.J.) was utilized as the blowing agent. Methylene chloride also decreased the viscosity of both the polymeric MDI and the polyol. Poly[dimethylsiloxane-co-methyl(3-hydroxypropyl)siloxane]-graft-poly(ethylene glycol)methyl ether in 85% ethylene oxide (Product Number 48,240-4 Sigma-Aldrich, Inc. St. Louis, Mo.) was used as the surfactant. Stannous octoate (Product Number 287172 Sigma-Aldrich, Inc. St. Louis, Mo.) was the catalyst.

To prepare the polyurethane foam, approximately 1 g of polymeric MDI was transferred to a 20 mL glass scintillation vial. Because the material was so viscous, it was conveyed by simply immersing the back end of a glass pipette into the material, removing the pipette, then “twirling” it to temporarily break the flow. Next, approximately 20 drops of surfactant, about 0.2 g, were added to the container. Approximately 0.5 g of methylene chloride was then added. The methylene chloride was added last because the volatility would cause it to evaporate during the addition of other components. The mixture was capped and shaken by hand until it became homogeneous. 3.32 g of polyol for each gram of polymeric MDI was added to a second cylindrical plastic vial approximately 4.5 cm across and 4.0 cm deep. This material was extremely viscous and was transferred by the same technique used for polymeric MDI. Between five and ten drops of catalyst, between 0.5 to 1.0 g, were then added to the second vial. Approximately 1.66 to 3.16 g methylene chloride was also added to the second vial. The total mass of methylene chloride in the two vials ranged from 2.16 g (approximately 50% of the total mass of the two monomers) to 3.67 g (not more than 85% of the total monomer mass). The mixture was capped and shaken by hand until it became homogeneous. Both containers were shaken to ensure homogeneity, and the contents of the first vial were quickly added by pipette to the second vial. The container was briefly shaken and within a few minutes, it became warm to the touch, and bubbles began to form and rise to the surface. After several more minutes, the material became firm. The samples were post-baked at 60° C. for about 24 h.

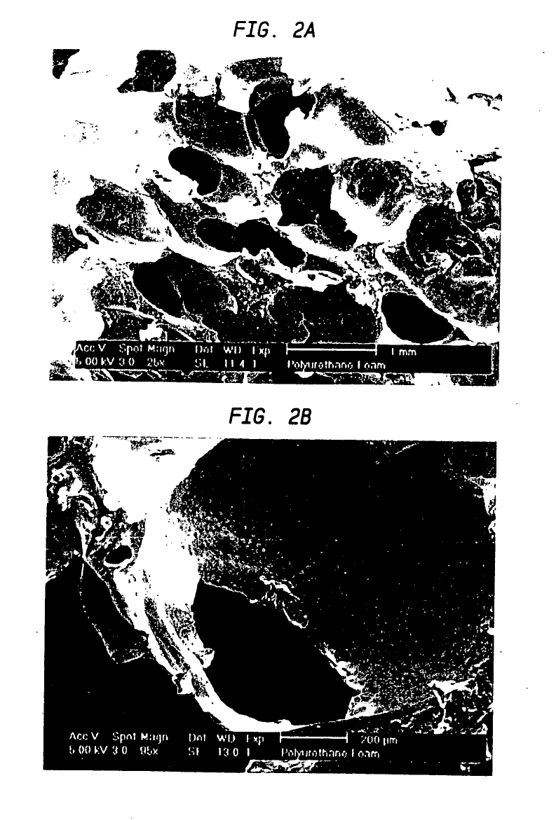

Each of the polyurethane samples exhibited an approximate 2000% increase in volume during the foaming process, producing a material that was approximately 2.2% solid by volume. The gas cells in these samples ranged in size from approximately 500 to 1000 μm. Additionally, the cell structure was slightly anisotropic because the bubbles tended to become elongated in the direction of rise. SEM images of the polyurethane material are shown in FIG. 2. FIG. 2A shows several cells that have been exposed by cutting the sample. Note that the cells show elongation along a diagonal axis. This distortion occurs during the foaming process. FIG. 2B shows the polyurethane at a higher magnification. This image shows the interconnectivity between two adjacent cells. This open-cell phenomenon is undesirable in insulating rigid polyurethane foams. Note that the cells show elongation along a diagonal axis. This distortion occurs during the foaming process.

### Example 2

### Synthesis of L₃-Silica

For a 10 g L₃ liquid crystal solution, 1.628 g of cetylpyridinium chloride monohydrate (CpCl) (Product Number 85,556-1 Sigma-Aldrich, Inc. St. Louis, Mo.), 1.872 g hexanol (Product Number 31638 Alfa Aesar Ward Hill, Mass.) and 6.500 g HCl (0.2N, aq) solvent were used to make a 65% by volume solvent solution. The hexanol and CpCl were combined and thoroughly mixed either with a magnetic Teflon™ stirbar or with an automatic “wrist shaker” for about 20 minutes to ensure that the hexanol entirely wetted the CpCl. The resultant mixture resembled a white paste. There should not be a layer of hexanol above the CpCl powder. If the paste is not sufficiently homogeneous, the formation of the thermodynamically stable L₃ can be retarded by kinetic barriers. The HCl was added to the hexanol-CpCl paste. The hexanol-CpCl paste/HCl mixture was stirred with a Teflon™ stirbar until the solution appeared clear and had no visible traces of powder, about for more than 20 minutes. Although the L₃ phase is thermodynamically stable, the liquid crystal can become kinetically trapped in a different morphology in the absence of vigorous stirring. The solution was then put aside for at least 24 h.

Because the L₃ phase is bordered on either side by Lα, a lamellar phase, an optical test was performed to determine whether the L₃ phase has been formed. The sample to be tested was placed between two polarizing lenses and subjected to bright backlighting. The lenses were then rotated with respect to each other. An L₃ phase is transparent and isotropic, so a sample of L₃ should appear uniform at all lens angles. When subjected to the same test, the Lα phase, which is transparent but not isotropic, will exhibit opalescent birefringence. Although the absence of birefringence does not confirm the existence of L₃, the presence of such indicates that L₃ is not formed. No solutions that exhibited birefringence were used in the subsequent temptation step.

13.770 g of tetramethoxysilane (TMOS) (Product Number 87682, Sigma-Aldrich, Inc., St. Louis, Mo.) was added after allowing the L₃ liquid crystal to sit for at least 24 h. The TMOS was often left on the scale for a few seconds to check for weight loss. If the mass of the TMOS sample noticeably decreased, that may have been an indication that the TMOS solution had undergone partial hydrolysis and that methanol was evaporating from the solution. If that was the case, a new supply of TMOS was obtained. The TMOS was added to the L₃ liquid crystal extremely slowly. Because the hydrolysis reaction is both quick and exothermic, it can generate sufficient heat to cause the hexanol to evaporate and thereby destroy the L₃ structure. Typically, the TMOS was added drop-wise using a glass pipette. If the solution began to feel warm, the addition was paused until the vial returned to room temperature. Using this procedure, TMOS was added at a rate of approximately 0.5 g per minute. After the TMOS solution was added, the sample was put aside until gelation occurred. The sample size and the relative amount of TMOS both affect the amount of time required for gelation to occur, but it generally occurred within several days.

After complete gelation, the L₃ monolith resembled a block of glass that conformed to the shape of the scintillation vial. The sample was removed from the vial by using a metal spatula to break the L₃-silica into several relatively large pieces. These pieces were then ground into a fine powder by using a mortar and pestle. There was a “crunching” sound as the particles were broken apart; this sound could be differentiated from the “grinding” sound associated with the simple agitation of a powder. Thus, the presence of the crunching sound indicated that particles were being broken apart. Grinding was judged complete when the crunching sound ceased, but the samples were ground for several minutes thereafter to help ensure that the entire sample had been thoroughly broken apart. The resulting powder was immersed in methanol and shaken for several minutes and then put aside for about 24 h. After 24 h, the particles had settled to the bottom of the vial and the methanol was pipetted off the top of the sample. Methanol was added again, and the process was repeated. After pipetting the methanol off for the second time, the powder was placed in a 60° C. oven until the powder was dry. The methanol washes cleaned the samples of both residual HCl and CpCl.

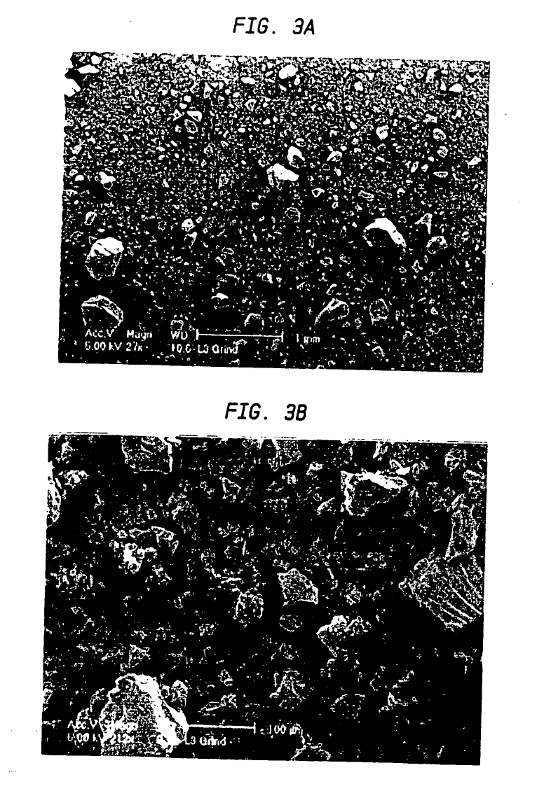

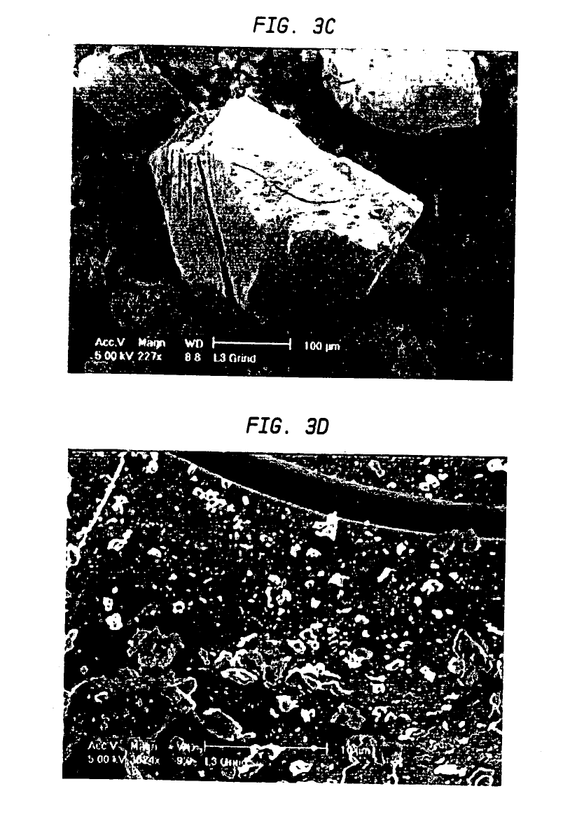

The L₃-silica particles produced via the mechanical grinding of the monolithic materila ranged in size from 1 μm to 500 μm. SEM images of the powder are shown in FIG. 3. FIGS. 3A to 3D show the particles in increasing magnification.

### Example 3

### Preparation of L₃-Silica/Polyurethane Composite

One gram of dried L₃-silica powder was placed in a cylindrical plastic container that was approximately 4.5 cm across and 4.0 cm deep. The L₃-silica powder that was used for the production of the composite was produced from a 67.9% HCl fraction L₃ liquid crystal and was silicified using 100.0% TMOS. The same general procedure for making the L₃ silica powder as described in Example 2 was used, except for 67.9% solvent content the following quantities were used to make and silicify 10 g of L₃ solution: 1.493 g CpCl.H2O, 1.717 g hexanol, 6.790 g 0.2NHCl (aq) and 14.353 g TMOS.

The two vials of polyurethane precursor were prepared as described in EXAMPLE 1.

The polyurethane precursor containing polyol, surfactant, catalyst and methylene chloride was added to the L₃ silica powder in equivolumes, that is, 5 ml of powder was mixed with 5 ml of polyurethane precursor. The mixture was shaken by hand for a few seconds to intimately mix the powder and polyurethane precursor. Then the polyurethane precursor mixture containing polymeric MDI was added to the mixture. The vial was then briefly but vigorously shaken and then allowed to stand. The material increased in volume after a few minutes.

The L₃-silica made up approximately 50% of the volume of the composite before foaming. This estimation was based on the observation that when the liquid polyurethane precursors were added, the apparent level of material in the container increased by about 50%. The estimation was also based on the assumption that the silica powder packed with a density of 75% and that the polyurethane precursors exactly filled the interstitial spaces between the silica powder particles. The total volume expansion of the composite mixture was approximately 100%, which corresponded to volume expansion of the polyurethane fraction of about 200%.

It is undesirable for the polyurethane precursors to infiltrate into the nanostructure of the L₃ silica because the insulating properties of the ceramic depend upon the presence of a gaseous phase within the channels. In order to directly test for the infiltration of the polyurethane monomers into the L₃-silica nanostructure, the polyurethane ingredients without catalyst were poured onto an L₃-silica monolith. Because these components have a slight yellow coloration, infiltration into the monolith would be visible as an advancing front of coloration within the ceramic. The direct test for infiltration indicated that polyurethane did not infiltrate the L₃-silica structure. Additionally, when the polyurethane precursors were poured over the L₃-silica powder, they formed liquid beads on the surface of the packed powder. This effect indicated the incompatibility of the surface chemistries of polyurethane and of silica. Only with mechanical agitation did the powder become dispersed in the liquid.

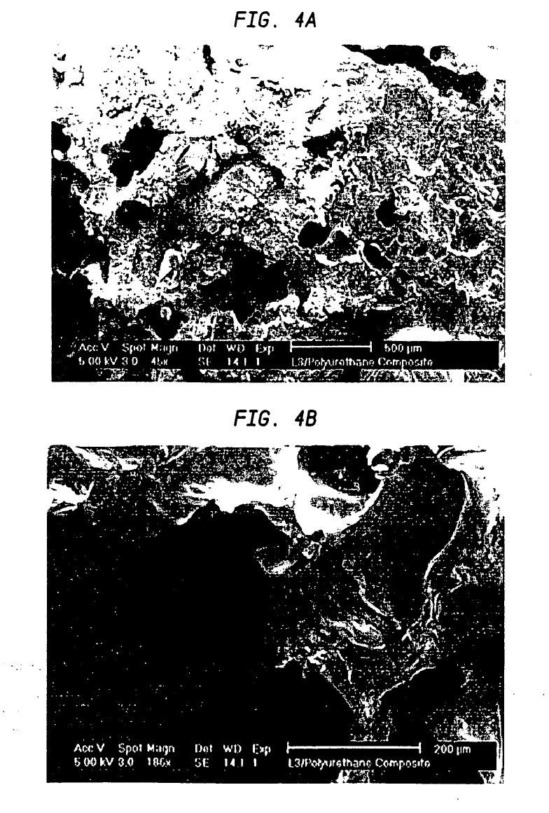

SEM images of the L₃-silica/polyurethane composite are shown in FIG. 4. Some agglomeration of silica particles appeared within the polyurethane matrix. The presence of the silica particles is shown in the SEM image of FIG. 4A, visible as surface roughness that does not appear in the image of simple polyurethane foam shown in FIG. 2. FIG. 4B shows the cell structure of the L₃-silica/polyurethane composite at a higher magnification. The fine cell structure is readily apparent. The gaseous cells of the composite were from 200 to 500 μm across, roughly half the size of the cells found in the polyurethane foams alone. It was observed that the bubbles produced in the composite specimens formed sooner and more uniformly than the bubbles of the pure polyurethane samples.

In order to estimate what fraction of the solid volume of the composite was L₃-silica, the density of both monolithic L₃-silica and solid polyurethane was measured via water displacement. The overall density of L₃-silica was 0.3 g/cm³. Because the density of amorphous silica is 2.3 g/cm³ the solid fraction of methanol-washed L₃-silica was approximately 13%. The density of solid polyurethane was found to be 1.3 g/cm³. Based upon the mass of each constituent and the calculated densities, the silica was estimated to make up 65% of the solid volume.

### Example 4

### Thermal Conductivity Measurements

In order to measure the thermal conductivity of the material, samples were cast as thin disks and mounted between two pieces of aluminum foil. This sandwich structure was then placed on a digital hotplate. A thermocouple (TC) was used to monitor the temperature of the top surface as a function of time. The system was considered to be at steady state when the temperature stopped changing. Additionally, the surface temperature of the hotplate at the location where the sample was placed was directly measured after the sample was removed. Because the apparatus was set up in a fume hood, there was a substantial air flow over the surface of the sample. In order to reduce this effect, a large plastic shield was placed just in front of the hotplate. After the addition of the shield, the steady state surface temperatures increased by several degrees. Three samples were measured using this hot plate technique: one composite specimen made as described in EXAMPLE 3, and two polyurethane specimens made as described in EXAMPLE 1. Each sample was cast as a disk approximately 4 cm in diameter. One polyurethane disk had a thickness of 1.5±0.1 cm (Polyurethane Sample A); the other polyurethane sample (Polyurethane Sample B) and the composite specimen were 0.6±0.1 cm thick. Each sample was measured at two hotplate surface temperatures (T1): 60.2° C. and 75.1° C. These surface temperatures corresponded to hotplate settings of 100° C. and 150° C. respectively. The temperature of the ambient air (T3) was 20.5° C. in all cases. For these temperature settings, there were fluctuations of approximately 0.5° C. at the sample surface (T3). These fluctuations had a period of approximately 30 s and were most likely due to air currents. The steady state value was taken as the average of several values taken over the course of two minutes.

The thermal conductivity was measured and calculated by known methods, for example, as described in S. Middleman, An Introduction to Mass and Heat Transfer (NY: Wiley, 1998) pp. 379-380.

The thermal conductivity data for the two polyurethane samples formed in Example 1 and the composite formed in Example 3 is shown in Table 1.

TABLE 1

| | T₁ = 60.2 ± 0.2° C. | T₁ = 75.1 ± 0.2° C. |
|---|---|---|
| T₂ Composite | 42.0 ± 0.5° C. | 53.3 ± 0.5° C. |
| k Composite | 0.007 h W/m · K | 0.009 h W/m · K |
| T₂ Polyurethane A | 34.6 ± 0.5° C. | 44.5 ± 0.5° C. |
| k Polyurethane A | 0.008 h W/m · K | 0.01 h W/m · K |
| T₂ Polyurethane B | 52.4 ± 0.5° C. | 65.6 ± 0.5° C. |
| k Polyurethane B | 0.02 h W/m · K | 0.03 h W/m · K |

T1 = hotplate surface temperature.
T2 = sample surface temperature
k = thermal conductivity

Note that in each case the value for thermal conductivity, k, retains a factor of convective heat transfer coefficient h.

From the data, it can be seen that the lowest value of polyurethane conductivity is lower than the highest value for the composite conductivity. Indeed, the differences observed for the values of thermal conductivity may be within experimental error. The average composite conductivity was significantly lower than the average polyurethane value; the average thermal conductivity of the composite is 44% that of the foam. Additionally, it should be remembered that the polyurethane sample A is losing more heat through the sample edges, so the conductivity of that sample will tend to be underestimated, whereas polyurethane sample B and the composite sample have nearly identical geometry, so the comparison between the composite and polyurethane sample B should be given more weight. Note that the calculated value of k is greater at the higher temperature for each specimen. This phenomenon may indicate a systematic violation of the assumptions utilized in the heat transport equations.

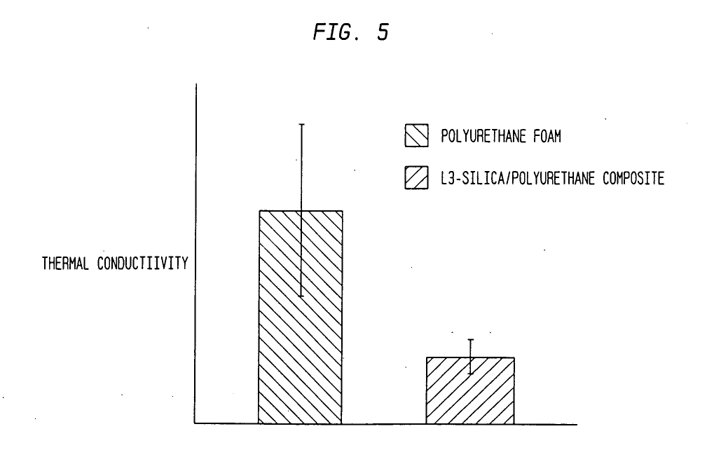

If only the thinner of the two polyurethane foam samples is considered, the sample with a geometry more closely resembling the composite sample, the average thermal conductivity of the composite is 32% that of the simple polyurethane. The 95% confidence interval indicates that the improved thermal insulation properties of the composite are statistically significant. This data is summarized in FIG. 5.

### Example 5

L₃ silica powder prepared as described in EXAMPLE 2 with a particle size between 1-500 microns was crushed and sifted through a fine sifter, resulting in particles about 150 microns in size having irregular shapes. Rigid polyurethane foam was prepared from the following ingredients:

| | | |
|---|---|---|
| Polyol mixture | DSD 302.01 (Dow) | 100 parts |
| Polyisocyanate | Voratec SD 100 (Bayer) | 140 parts |
| Blowing agent | HFC 141b | 24 parts |

Foaming reactions were carried out in polypropylene (PP) cups. L3, polyol mixture and the foaming agent (LPOF) were weighed into the first cup and mixed well. Even at 15% by weight of L₃ incorporation, no major increase or mixing problems were observed in polyol viscosity. Polyisocyanate (NCO) was weighed into a separate cup. To produce the foam, NCO was added into the LPOF mixture and the system was vigorously stirred for 5-7 seconds. Afterwards it was left to foam. Foams with 0, 5, 10 and 15% by weight of L₃ were produced. The chemical composition of each mixture is given in Table 2.

TABLE 2

Formulation #

| Component | 2 (Control) | 3 | 4 | 5 |
|---|---|---|---|---|
| Polyol | 3.00 | 3.00 | 3.00 | 3.00 |
| Polyisocyanate | 4.20 | 4.20 | 4.20 | 4.20 |
| Blowing agent | 0.72 | 0.72 | 0.72 | 0.72 |
| L₃ | — | 0.41 | 0.88 | 1.40 |
| L₃ (% by weight) | 0 | 4.9 | 10.0 | 15.0 |

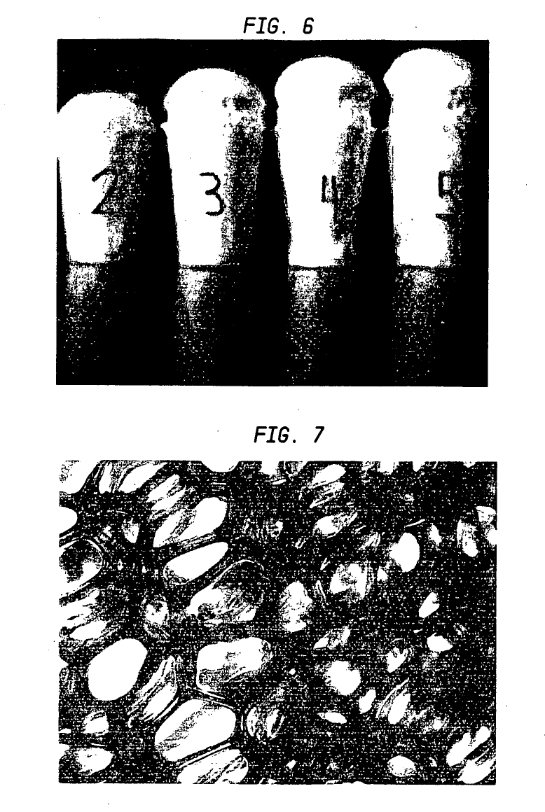

Foaming reactions were very fast and completion of the foam rise took about 40-50 seconds. As shown in FIG. 6, as the amount of L₃ in the system increased, the foam height (volume) also increased.

The pore size, closed cell content and density of the samples are provided in Table 3.

TABLE 3

| | | |
|---|---|---|
| | | Cell size |
| Open Cell | Density | micron |

| | content % | Kg/m3 | perpendicular | parallel |
|---|---|---|---|---|
| Sample 2 | 15.0 | 28.1 | 303 | 310 |
| Sample 3 | 24.4 | 27.8 | 350 | 352 |
| Sample 4 | 14.9 | 24.1 | 281 | 337 |
| Sample 5 | 36.2 | 25.2 | 316 | 328 |

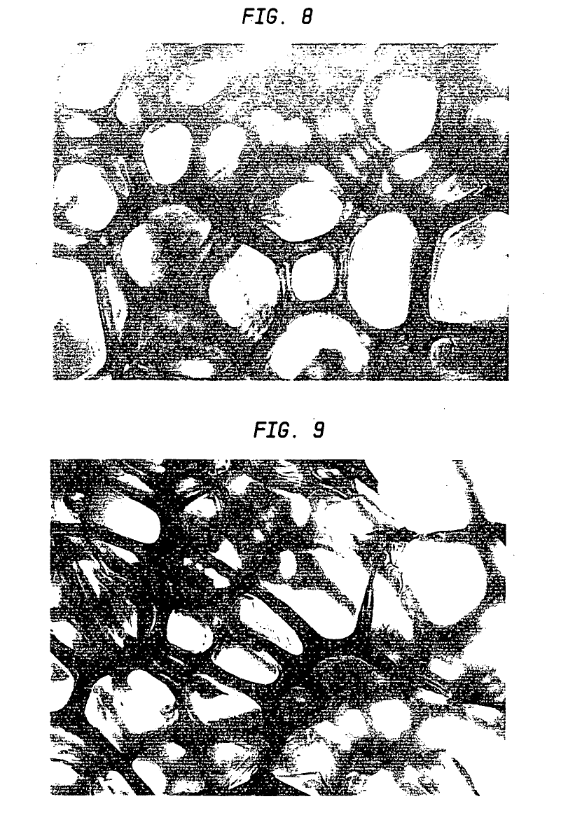

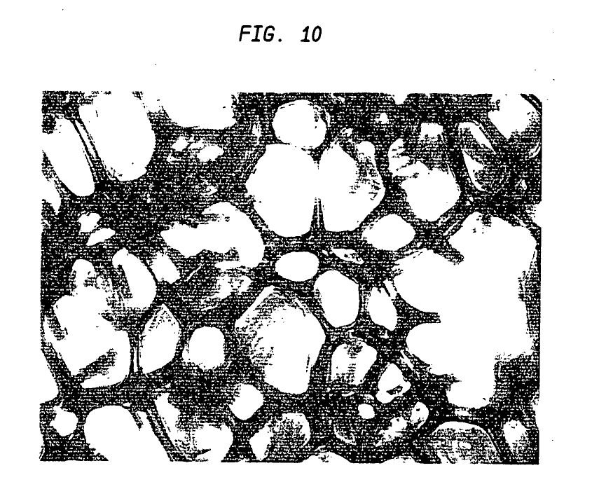

Optical microscope images of Samples 2, 3, 4 and 5 are provided in FIGS. 7, 8, 9 and 10, respectively. The images correlate well with the data in Table 3 with respect to the uniformity of the cell sizes regardless of the presence of L₃ in the system.

### Example 6

### Preparation of Rigid Polyurethane Composite

B-Side Stock Solution

| | |
|---|---|
| Voranol 360 | 200 pbw |
| Surfactant (Tegostab B 8404) | 3.0 pbw |
| Dabco 33LV | 0.8 pbw |
| Dabco T-12 (Dibutylindilaurate) | 0.2 pbw |

Sixteen ounce polypropylene (PP) beverage cups were used as a mold. Control foam and three L3 loadings at 5, 10, and 15% by weight were prpared.

Procedure

1. Treat the PP cup with a touch of non-silicone mold release agent and dry

2. Weigh B-side into PP cup

3. Weigh L3 as prepared in Example 2 into the cup

4. Mix them well using a stainless steel spatula until homogenous (approximately 1 minute)

5. Add HFC-141b and mix the system well with the spatula for 1-2 minutes until homogenous. Check weight loss due to evaporation of HFC. Add more if necessary.

6. Add isocyanate and mix the system with stainless steel spatula for 1 minute

7. Let the foam rise at room temperature

Compositions of the Foam Forumations:

| Sample No. | B-Side (g) | Isocyanate (g) | HFC (g) | L3 (g) | L3 (%) |
|---|---|---|---|---|---|
| 2 | 15.0 | 13.3 | 3.7 | 0 | 0 |
| 3 | 15.0 | 13.3 | 3.7 | 1.68 | 5 |
| 4 | 15.0 | 13.3 | 3.7 | 1.68 | 5 |
| 5 | 15.0 | 13.3 | 3.7 | 3.55 | 10 |
| 6 | 15.0 | 13.3 | 3.7 | 5.65 | 15 |

In the formulations above, percentage L3 was calculated by including the weight of the HFC. If this is excluded, then the level of L3 becomes 5.6, 11.1, and 16.9%, respectively.

Having thus described the invention in detail, it is to be understood that the foregoing description is not intended to limit the spirit and scope thereof. What is desired to be protected by Letters Patent is set forth in the appended claims.

1. A thermal insulating composite comprising an L₃-silica liquid crystal and rigid polyurethane.

2. The composite of claim 1 comprising 2-30% by weight L₃-silica and 70-98% by weight polyurethane foam.

3. The composite of claim 1 having a thermal conductivity of 0.008 to 0.015 W/m·K.

4. The composite of claim 1 having a gaseous cell size of from 200 to 500 μm in diameter.

5. The composite of claim 1 wherein the L₃-silica is produced by templating with a ceramic precursor a lyotropic liquid crystalline L₃ phase, wherein the L₃ phase consists of a three-dimensional, random, nonperiodic network packing of a multiple connected continuous membrane.

6. The composite of claim 5, wherein the ceramic precursor is a metalloorganic or metal salt precursor to oxide or non-oxide ceramics.

7. The composite of claim 6, wherein the ceramic precursor is tetramethoxysilane (TMOS) or tetraethoxysilane (TEOS).

8. A method of producing a thermal insulating composite comprising:
providing a polyurethane precursor comprising a polymeric isocyanate;
providing a polyurethane precursor comprising a polyol;
providing an L₃-silica liquid crystal;
mixing the L₃-silica liquid crystal with the polyol precursor; and
mixing the liquid crystal and polyol mixture with the polymeric isocyanate precursor to form a L₃-silica liquid crystal/rigid polyurethane thermal insulating composite.

9. The method of claim 8 wherein the total polyurethane precursors are present at 70-98% by weight and the L₃-silica is present at 2-30% by weight.

10. The method of claim 8 wherein the L₃-silica is produced by templating with a ceramic precursor a lyotropic liquid crystalline L₃ phase, wherein the L₃ phase consists of a three-dimensional, random, nonperiodic network packing of a multiple connected continuous membrane.

11. The method of claim 10, wherein the ceramic precursor is a metalloorganic or metal salt precursor to oxide or non-oxide ceramics.

12. The method of claim 11, wherein the ceramic precursor is tetramethoxysilane (TMOS) or tetraethoxysilane (TEOS).

13. The method of claim 8 wherein the L₃-silica has a particle size of from 1 to 500 μm.
